(19) United States
(12) Patent Application Publication
(10) Pub. No.: US 2021/0058218 A1
(43) Pub. Date: Feb. 25, 2021

(54) USER TERMINAL AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Jing Wang, Beijing (CN); Chongning Na, Beijing (CN)

(73) Assignee: NTT DOCOMO, INC., Tokyo (JP)

(21) Appl. No.: 16/969,466

(22) PCT Filed: Feb. 15, 2018
(86) PCT No.: PCT/JP2018/005343

§ 371 Date: Aug. 12, 2020

(51) Int. Cl. H04L 5/00; H04W 72/04; H04W 80/02; H04W 24/08

(52) U.S. Cl. CPC H04L 5/0098; H04W 72/042; H04W 24/08; H04W 72/0453; H04W 80/02; H04L 5/0092

(57) ABSTRACT

To properly perform communication also in the case of supporting activation of a plurality of BWPs, a user terminal according to one aspect of the present disclosure has a receiving section that receives downlink control information for indicating activation of a predetermined BWP among one or more partial frequency bands (BWP: Bandwidth Part) configured within a carrier, and a control section that controls activation of one or a plurality of BWPs based on at least one of the downlink control information, MAC control information and higher layer signaling.

### TECHNICAL FIELD

The present invention relates to a user terminal and radio communication method in the next-generation mobile communication system.

### BACKGROUND ART

In UMTS (Universal Mobile Telecommunications System) networks, for the purpose of higher data rates, low delay and the like, Long Term Evolution (LTE) has been specified (Non-patent Document 1). Further, for the purpose of wider bands and higher speed than LTE, successor systems (e.g., also referred to as LTE-A (LTE-Advanced), FRA (Future Radio Access), 4G, 5G, 5G+ (plus), NR (New RAT), LTE Rel.14, 15-, etc.) to LTE have also been studied.

Further, in the existing LTE system (e.g., LTE Rel.8-13), using a subframe of 1 ms as a scheduling unit, communication on downlink (DL) and/or uplink (UL) is performed. For example, in the case of Normal Cyclic Prefix (NCP), the subframe is comprised of 14 symbols with subcarrier spacing of 15 kHz. The subframe is also called a transmission time interval (TTI: Transmission Time Interval) and the like.

Furthermore, based on downlink control information (DCI) (also referred to as DL assignment, etc.) from a radio base station (e.g., eNB: eNodeB), a user terminal (UE: User Equipment) controls reception of a DL data channel (e.g., also referred to as PDSCH: Physical Downlink Shared Channel, DL shared channel, etc.). Further, based on DCI (also referred to as UL grant, etc.) from the radio base station, the user terminal controls transmission of a UL data channel (e.g., also referred to as PUSCH: Physical Uplink Shared Channel, UL shared channel, etc.)

### PRIOR ART DOCUMENT

### Non-Patent Document

[Non-patent Document 1] 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### DISCLOSURE OF INVENTION

### Problems to be Solved by the Invention

In future radio communication systems (hereinafter, described as NR), it is studied to use one or more partial frequency bands (also referred to as Partial Band, Bandwidth Part (BWP), etc.) within a carrier (also referred to as a component carrier (CC), system band, or the like) in DL and/or UL communication (DL/UL communication).

Thus, in the case of allowing one or more frequency bands (e.g., BWPs) used in DL/UL communication to be configured within a carrier, it is conceivable that activation and/or deactivation of the BWP is performed.

Further, while configuring a plurality of BWPs for a UE, it is also conceivable that a plurality of BWPs is activated to control DL/UL communication. However, in the case of concurrently activate a plurality of BWPs, studies have not proceeded on how to control operation of activation and/or DL/UL communication. In the case of permitting activation of a plurality of BWPs, unless a proper control method is used, it is not possible to perform flexible control, and there is the risk that deterioration occurs in communication throughput, communication quality and the like.

In the present disclosure, it is an object to provide a user terminal and radio communication method capable of properly performing communication, also in the case of supporting activation of a plurality of BWPs.

### Means for Solving the Problem

A user terminal according to one aspect of the present disclosure is characterized by having a receiving section that receives downlink control information for indicating activation of a predetermined BWP among one or more partial frequency bands (BWP: Bandwidth Part) configured within a carrier, and a control section that controls activation of one or a plurality of BWPs based on at least one of the downlink control information, MAC control information and higher layer signaling.

### Advantageous Effect of the Invention

According to the present invention, also in the case of supporting activation of a plurality of BWPs, it is possible to properly perform communication.

### BRIEF DESCRIPTION OF DRAWINGS

FIGS. 1A to 1C are diagrams showing one example of BWP configuration scenarios;

FIG. 2 is a diagram showing one example of control of activation/deactivation of BWP;

FIGS. 3A and 3B are diagrams showing one example in the case of activating a plurality of BWPs;

FIGS. 4A and 4B are diagrams showing one example of tables used in activation of BWPs;

FIGS. 5A and 5B are diagrams showing another example of tables used in activation of BWPs;

FIGS. 6A and 6B are diagrams showing still another example of tables used in activation of BWPs;

FIGS. 7A and 7B are diagrams showing one example of RLM control in the case of activating a plurality of BWPs;

FIG. 8 is a diagram showing one example of a schematic configuration of a radio communication system according to this Embodiment;

FIG. 9 is a diagram showing one example of an entire configuration of a radio base station according to this Embodiment;

FIG. 10 is a diagram showing one example of a function configuration of the radio base station according to this Embodiment;

FIG. 11 is a diagram showing one example of an entire configuration of a user terminal according to this Embodiment;

FIG. 12 is a diagram showing one example of a function configuration of the user terminal according to this Embodiment; and

FIG. 13 is a diagram showing one example of hardware configurations of the radio base station and user terminal according to this Embodiment.

### BEST MODE FOR CARRYING OUT THE INVENTION

In a future radio communication system (e.g., NR, 5G or 5G+), it is studied to assign a carrier (also referred to as a component carrier (CC), cell, system band or the like) with a bandwidth (e.g., 100 MHz to 800 MHz) wider than in the existing LTE system (e.g., LTE Rel.8-13).

On the other hand, in the future radio communication system, it is expected that coexist a user terminal (also referred to as Wideband (WB) UE, single carrier WB UE, etc.) having the capability of performing transmission and/or reception (transmission/reception) in the entire carrier, and another user terminal (also referred to as BW (Bandwidth) reduced UE, etc.) that does not have the capability of performing transmission/reception in the entire carrier.

Thus, in the future radio communication system, since it is expected that a plurality of user terminals (various BW UE capabilities) coexists in a bandwidth to support, it is studied to configure one or more partial frequency bands semi-statically within a carrier. Each frequency band (e.g., 50 MHz, 200 MHz or the like) within the carrier is called a partial band, Bandwidth Part (BWP) or the like.

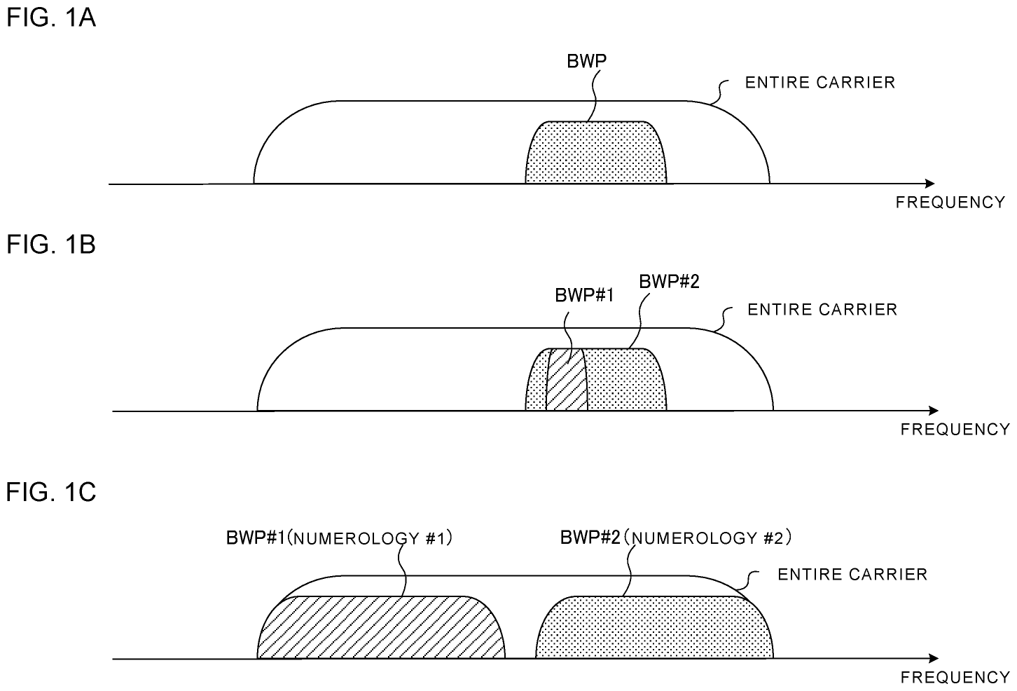

FIG. 1 contains diagrams showing one example of BWP configuration scenarios. FIG. 1A illustrates a scenario (Usage scenario #1) that one BWP is configured for a user terminal within one carrier. For example, in FIG. 1A, the BWP of 200 MHz is configured within the carrier of 800 MHz. Activation or deactivation of the BWP may be controlled.

Herein, activation of a BWP is a state of enabling the BWP to be used (or transferring to the state of enabling the BWP to be used), and is also called activation, enabling or the like of BWP configuration information. Further, deactivation of a BWP is a state of disabling use of the BWP (or transferring to the state of disabling use of the BWP), and is also called de activation, disabling or the like of the BWP configuration information. By scheduling a BWP, the BWP is activated.

FIG. 1B illustrates a scenario (Usage scenario #2) that a plurality of BWPs is configured for a user terminal within one carrier. As shown in FIG. 1B, at least a part of the plurality of BWPs (e.g., BWPs #1 and #2) may overlap one another. For example, in FIG. 1B, BWP #1 is a part of a frequency band of BWP #2.

Further, activation or deactivation may be controlled in at least one of the plurality of BWPs. For example, in FIG. 1B, in the case where transmission/reception of data is not performed, the BWP #1 is activated, and in the case where transmission/reception of data is performed, the BWP #2 may be activated. Specifically, when data to transmit/receive occurs, switching from the BWP #1 to the BWP #2 is performed, and when transmission/reception of the data finishes, switching from the BWP #2 to the BWP #1 may be performed. By this means, the user terminal does not need to always monitor the BWP #2 with a bandwidth wider than the BWP #1, and therefore, is capable of suppressing power consumption.

In addition, in FIGS. 1A and 1B, a network (e.g., radio base station) may not assume that the user terminal performs reception and/or transmission out of a BWP in an active state. In addition, in FIG. 1A, it is not restricted at all that a user terminal for supporting the entire carrier transmits/receives a signal out of the BWP.

FIG. 1C illustrates a scenario (Usage scenario #3) that a plurality of BWPs is configured at different bands within one carrier. As shown in FIG. 1C, different types of numerology may be applied to the plurality of BWPs. Herein, the numerology may be at least one of subcarrier spacing, symbol length, slot length, cyclic prefix (CP) length, slot (Transmission Time Interval (TTI)) length, the number of symbols per slot and the like.

For example, in FIG. 1C, BWPs #1 and #2 with different numerology are configured for a user terminal having the capability of performing transmission/reception in the entire carrier. In FIG. 1C, at least one of BWPs configured for the user terminal may be activated or deactivated, and one or more BWPs may be active at some time.

In addition, a BWP used in DL communication may be called DL BWP (frequency band for DL), and a BWP used in UL communication may be called UL BWP (frequency band for UL). In the DL BWP and UL BWP, at least a part of the frequency band may overlap one another. Hereinafter, in the case of not distinguishing between the DL BWP and the UL BWP, the BWP is used as a generic name.

At least one of DL BWPs (e.g., DL BWP included in a primary CC) configured for a user terminal may include a control resource region as an allocation candidate of a DL control channel (DCI). The control resource region may be called a control resource set (CORESET), control subband, search space, search space resource set, control region, control subband, NR-PDCCH region and the like.

A user terminal monitors one or more search spaces within a control resource set to detect DCI for the user terminal. The search space may include common search space (CSS) where DCI (e.g., group DCI or common DCI) common to one or more user terminals is allocated and/or user terminal (UE)-specific search space (USS: UE-specific Search Space) where user terminal-specific DCI (e.g., DL assignment and/or UL grant) is allocated.

Using higher layer signaling (e.g., RRC (Radio Resource Control) signaling, etc.), the user terminal may receive configuration information (CORESET configuration information) of the control resource set and configuration information of the search space. The CORESET configuration information may indicate at least one of a frequency resource (e.g., the number of RBs and/or start RB index), time length (duration), REG (Resource Element Group) bundle size (REG size), transmission type (e.g., interleave, non-interleave) and the like of each control resource set, and the search space configuration information may indicate at least one of a time resource (e.g., start OFDM symbol number), periodicity (e.g., monitor periodicity for each control resource set), type (e.g., CSS, USS) of search space and the like of each search space.

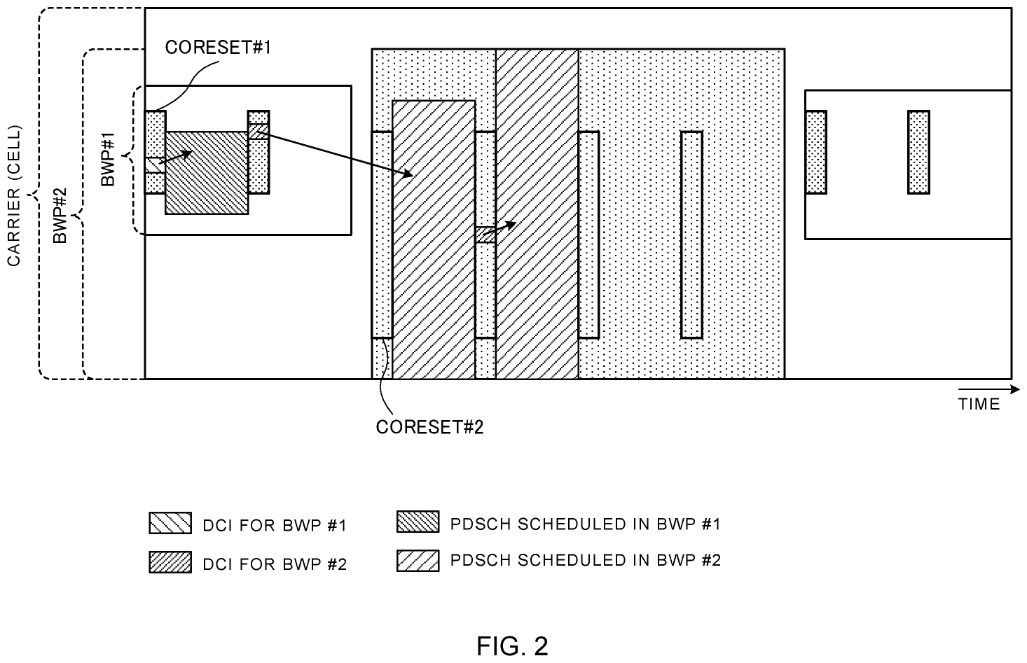

Referring to FIG. 2, descriptions will be given to control of activation and/or deactivation (also referred to as activation/deactivation, switching, determining, etc.) of the BWP. FIG. 2 is a diagram showing a control example in the case of activating one BWP (the case of switching the BWP to activate). In addition, in FIG. 2, the scenario shown in FIG. 1B is assumed, and it is also possible to apply control of activation/deactivation of the BWP to the scenarios shown in FIGS. 1A and 1C and the like, as appropriate.

Further, in FIG. 2, it is assumed that CORESET #1 is configured within the BWP #1, and that CORESET #2 is configured within the BWP #2. Each of the CORESET #1 and CORESET #2 is provided with one or more search spaces. For example, in the CORESET #1, DCI for the BWP #1 and DCI for the BWP #2 may be allocated within the same search space, or may be allocated to respective different search spaces.

Furthermore, in FIG. 2, in the case where the BWP #1 is an active state, a user terminal monitors (performs blind decoding on) the search space within the CORESET #1 with predetermined periodicity (e.g., every one or more slots, every one or more mini-slots, or every predetermined number of symbols), and detects DCI for the user terminal.

The DCI may include information (BWP information) indicating a BWP to which the DCI corresponds. For example, the BWP information may be an index of the BWP, and is essentially a predetermined field value in the DCI. Further, the BWP index information may be included in DCI for downlink scheduling, may be included in DCI for uplink scheduling, or may be included in DCI of the common search space. Based on the BWP information in the DCI, the user terminal may determine a BWP in which a PDSCH or PUCCH is scheduled by the DCI.

In the case of detecting DCI for the BWP #1 in the CORESET #1, based on the DCI for the BWP #1, the user terminal receives a PDSCH scheduled (allocated) to predetermined time and/or frequency resources (time/frequency resources) in the BWP #1.

Further, in the case of detecting DCI for the BWP #2 in the CORESET #1, the user terminal deactivates the BWP #1, and activates the BWP #2. Based on the DCI for the BWP #2 detected in the CORESET #1, the user terminal receives a PDSCH scheduled to predetermined time/frequency resources of DL BWP #2.

In addition, in FIG. 2, the DCI for the BWP #1 and the DCI for the BWP #2 is detected at different timings in the CORESET #1, and a plurality of pieces of DCI for different BWPs may be capable of being detected at the same timing. For example, a plurality of search spaces that respectively corresponds to a plurality of BWPs is provided in the CORESET #1, and the plurality pieces of DCI of respective different BWPs may be transmitted in the plurality of search spaces. The user terminal may monitor a plurality of search spaces in the CORESET #1 to detect a plurality of pieces of DCI of different BWPs at the same timing.

When the BWP #2 is activated, the user terminal monitors (performs blinding decoding on) the search space in the CORESET #2 with predetermined periodicity (e.g., every one or more slots, every one or more mini-slots, or every predetermined number of symbols), and detects DCI for the BWP #2. Based on the DCI for the BWP #2 detected in the CORESET #2, the user terminal may receive a PDSCH scheduled to predetermined time/frequency resources of the BWP #2.

In addition, FIG. 2 illustrates the case where a predetermined time is provided for switching between activation and deactivation, and the predetermined time may not exist.

As shown in FIG. 2, in the case where the BWP #2 is activated using detection of the DCI for the BWP #2 in the CORESET #1 as a trigger, since it is possible to activate the BWP #2 without explicit instruction information, it is possible to prevent overhead associated with control of activation from increasing.

Further, in the case where a data channel (e.g., PDSCH and/or PUSCH) is not scheduled in the activated BWP fora predetermined period, the BWP may be deactivated. For example, in FIG. 2, since a PDSCH is not scheduled in DL BWP #2 for a predetermined period, the user terminal deactivates the BWP #2, and activates the BWP #1.

In addition, the maximum number of BWPs configurable per carrier may be beforehand determined. For example, in Frequency Division Duplex (FDD) (paired spectrum), maximum 4 DL BWPs and maximum 4 UL BWPs may be configured per carrier.

On the other hand, in Time Division Duplex (unpaired spectrum), maximum 4 pairs of DL BWP and UL BWP may be configured per carrier. In addition, in TDD, paired DL BWP and UL BWP may have different bandwidths with the same center frequency.

Further, a particular BWP may be beforehand determined for a user terminal. For example, a BWP (initial active BWP) for scheduling a PDSCH carrying system information (e.g., RMSI) may be defined by a frequency position and bandwidth of a CORESET where DCI for scheduling the PDSCH is allocated. Further, the same numerology as the RMSI may be applied to the initial active BWP.

Furthermore, a default BWP may be determined for a user terminal. The default BWP may be the above-mentioned initial active BWP, or may be configured by higher layer signaling (e.g., RRC signaling).

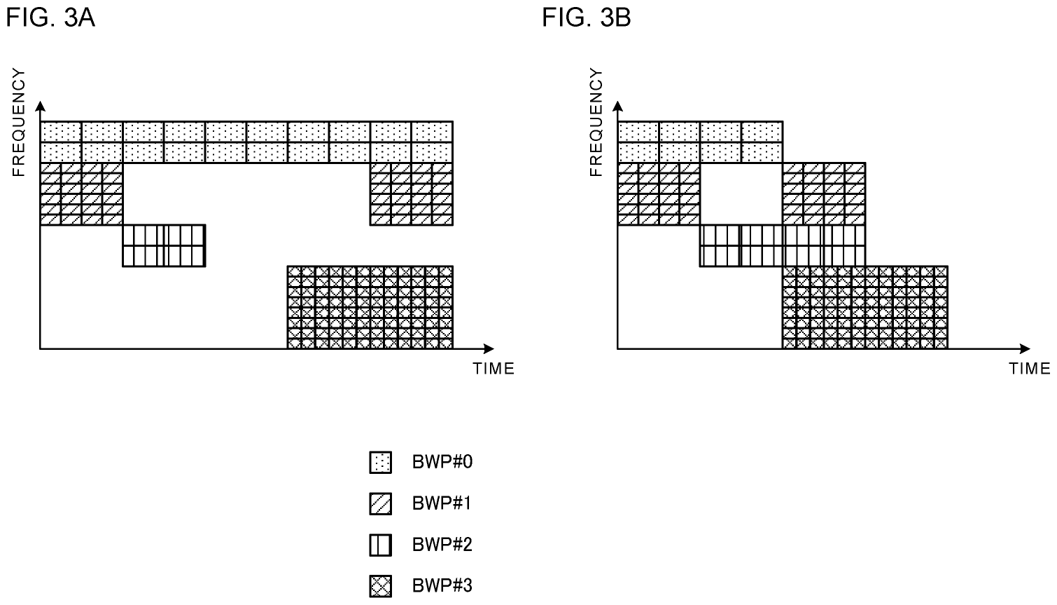

In addition, FIG. 2 illustrates the case where one BWP is activated in one carrier (cell) in some period. On the other hand, in the future radio communication system (e.g., NR), it is also expected that a plurality of BWPs configured within a carrier is concurrently activated to control DL/UL communication (see FIG. 3).

FIG. 3 illustrates one example in the case of concurrently activating a plurality of BWPs. In FIG. 3A, a predetermined BWP (herein, BWP #0) that is always activated in some period is configured, and the predetermined BWP (BWP #0) and another BWP (at least one of BWPs #1 to #3) are concurrently activated.

FIG. 3B illustrates the case where a predetermined BWP that is always activated is not configured, and each BWP is dynamically activated. In this case, it is essential only that at least one BWP is in an active state in some period, and that a plurality of BWPs is not activated in all periods. In addition, respective different types of numerology may be applied to a plurality of BWPs.

However, in the case of permitting operation (multiple activate BWP operation) for concurrently activating a plurality of BWPs, it becomes a problem how to control configuration of activation operation and the like. Alternatively, in the case of concurrently activating a plurality of BWPs, it becomes a problem how to control DL/UL communication.

Therefore, the inventors of this application studied control methods in case of permitting that a plurality of BWPs is concurrently activated in a predetermined carrier, and arrived at the invention of this application. For example, in one aspect of the present disclosure, it was conceived controlling activation of one or a plurality of BWPs, based on at least one of downlink control information, MAC control information and higher layer signaling.

One Embodiment of the present invention will be described below with reference to drawings. In addition, the BWP described below may be applied to each of DL BWP and UL BWP. Further, in the following description, it may be assumed that operation (single activate BWP operation) for activating one BWP refers to operation for activating only one BWP (without concurrently activating a plurality of BWPs) in some period, and that operation (multiple activate BWP operation) for activating a plurality of BWPs refers to operation permitted to concurrently activate a plurality of BWPs (including a period where only one BWP is activated).

### Aspect 1

In Aspect 1, in the case of permitting concurrent activation of a plurality of BWPs in a predetermined carrier, based on at least one of downlink control information, MAC control information and higher layer signaling, activation of one or a plurality of BWPs is controlled. For example, based on at least one of the downlink control information, MAC control information and higher layer signaling, the operation (single activate BWP operation) for activating one BWP and the operation (multiple activate BWP operation) for activating a plurality of BWPs is switched to control.

### <Downlink Control Information>

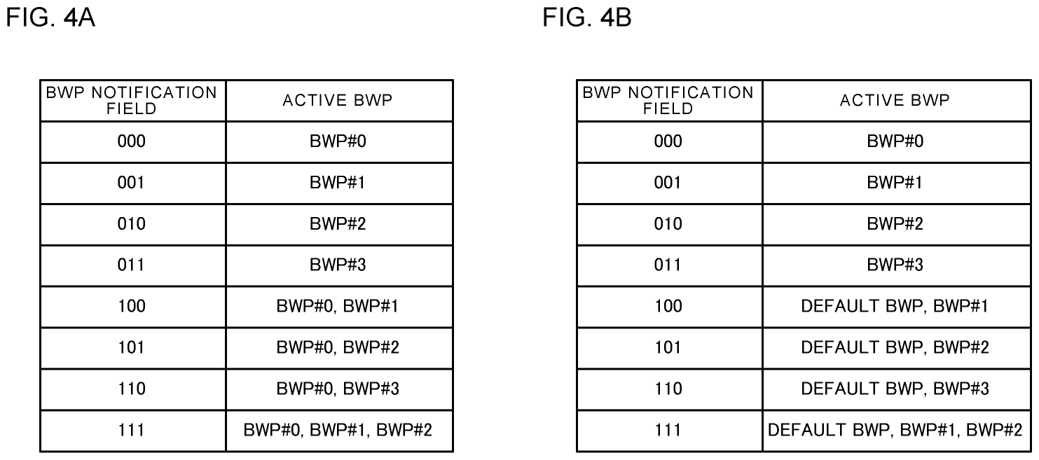

The base station may instruct the UE to activate one or a plurality of BWPs using the downlink control information. For example, using a predetermined bit field (which may be called a BWP indication field) included in the downlink control information, the base station notifies of one or a plurality of BWPs to activate (see FIG. 4). In addition, it is possible to apply a table in FIG. 4 to DL BWP and/or UL BWP.

FIG. 4A shows one example of the table for defining one or a plurality of BWP indexes for indicating activation using 3 bits. A part or the whole of BWP indexes that correspond to respective bit values of the BWP indication field may be beforehand defined by specifications, or may be configured for the UE from the base station using higher layer signaling and/or MAC CE. In addition, the BWP configuration (the number of BWP indexes) defined in the table is not limited to 3 bits.

In FIG. 4A, among 8 candidate bits, 4 candidate bits (herein, 000, 0001, 010, 011) are used to notify of one active BWP index. Further, remaining 4 candidate bits (herein, 100, 101, 110, 111) are used to notify of a plurality of active BWP indexes.

Further, each of 4 candidate bits to notify of a plurality of active BWPs is configured to include a predetermined BWP index (herein, BWP #0). Thus, by including a predetermined BWP index (fixed BWP index) in the candidate bits for notifying of a plurality of active BWPs, it is possible to make a configuration for always activating a particular BWP (e.g., see FIG. 3A). As a matter of course, it may be configured that candidate bits for notifying of a plurality of active BWPs include respective different BWP indexes.

In FIG. 4A, in notification of a plurality of active BWP indexes, the case is shown where each of the BWP indexes is explicitly notified, but the invention is not limited thereto. For example, as shown in FIG. 4B, in the case of designating a plurality of active BWPs, types of BWPs (or, combination of type of BWP and BWP index) may be used. FIG. 4B illustrates the case where a default BWP is included in each of the candidate bits for notifying of a plurality of active BWPs.

The default BWP may be beforehand configured for (notified) the UE from the base station. Alternatively, the default BWP may be the BWP (initial active BWP) initially activated by the UE. As one example, in the case where the base station does not notify of the default BWP, the UE may use the initially activated BWP as the default BWP. Further, in the operation for activating one BWP and operation for activating a plurality of BWPs, the configuration of the default BWP may be shared to use.

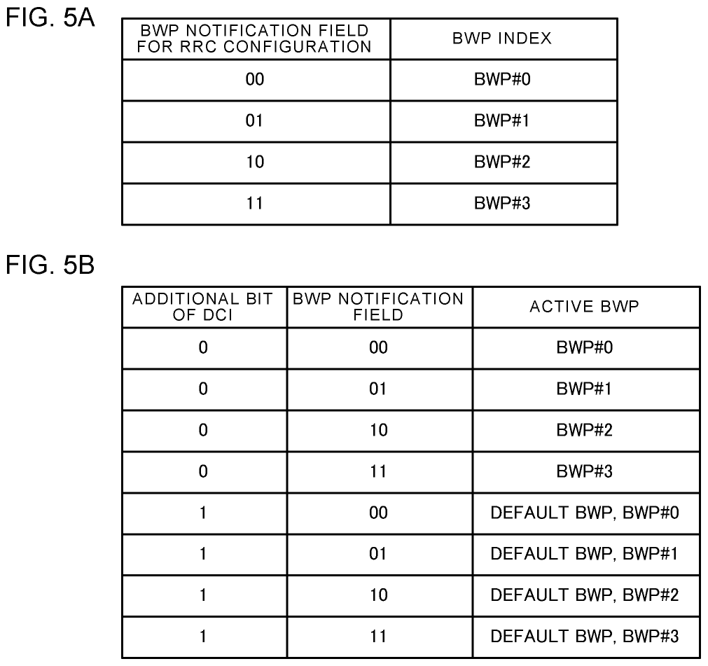

Further, for single active BWP index notification (single activate BWP operation) and multiple active BWP index notification (multiple activate BWP operation), common BWP candidate sets may be defined (see FIG. 5A).

Using the BWP notification field and an additional bit (e.g., 1 bit) included in the downlink control information, the base statin may notify whether the shared BWP candidate set is to activate one BWP or to activate a plurality of BWPs (see FIG. 5B).

In FIG. 5A, for the BWP notification field of predetermined bits (herein, 2 bits), BWP indexes are respectively configured. The BWP index that corresponds to each bit candidate may be beforehand defined by specifications, or may be notified the UE from the base station using higher layer signaling and/or MAC CE.

Based on the additional bit (herein, 1 bit) included in the DCI, the UE interprets the BWP notification field included in the DCI. For example, in the case where the additional bit is “0”, the UE judges that each bit candidate of the BWP notification field corresponds to a single activate BWP index to control activation of the BWP.

On the other hand, in the case where the additional bit is “1”, the UE judges that each bit candidate of the BWP notification field corresponds to multiple activate BWP indexes to control activation of the BWP. In FIG. 5B, in the case where the additional bit is “1”, as shown in FIG. 5A, in addition to the BWP index that corresponds to each bit candidate, control is performed to also activate a predetermined BWP (e.g., default BWP).

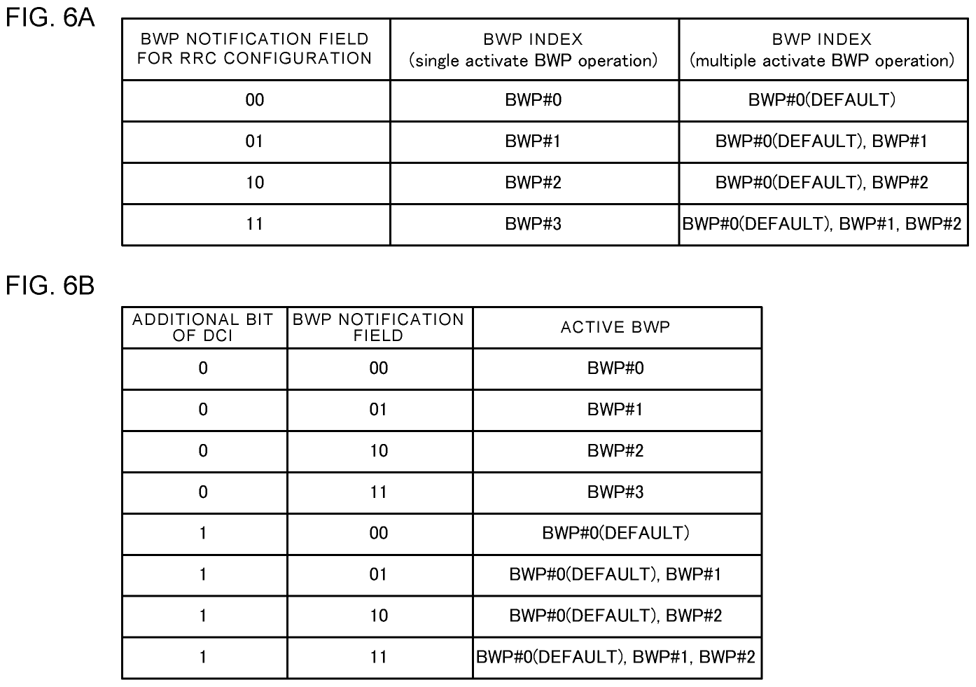

In addition, FIG. 5 illustrates the case of defining the common BWP candidate set to single active BWP index notification (single activate BWP operation) and multiple active BWP index notification (multiple activate BWP operation), but the invention is not limited thereto. For example, a set for single active BWP index notification and another set for multiple active BWP index notification may be defined independently (see FIG. 6A). Then, using the additional bit (e.g., 1 bit), the base station may notify which set is used (see FIG. 6B).

In FIG. 6B, in the case where the additional bit is “0”, the UE uses candidate bits configured for single active BWP index notification (single activate BWP operation) in FIG. 6A. On the other hand, in the case where the additional bit is “1”, the UE uses candidate bits configured for multiple active BWP index notification (multiple activate BWP operation) in FIG. 6A.

Thus, using the downlink control information, by notifying of a single active BWP index or a plurality of active BWP indexes, also in the case of activating a plurality of BWPs, it is possible to dynamically control active operation.

### <Higher Layer Signaling>

Using higher layer signaling (e.g., RRC signaling), the base station configures whether to activate one BWP (single activate BWP operation) or to activate a plurality of BWPs (multiple activate BWP operation) on the UE. Further, the station notifies the UE of information (e.g., index to activate) on the corresponding BWP by higher layer signaling.

For example, using signaling notified in RRC re-configuration, the base station may configure whether to activate one BWP (single activate BWP operation) or to activate a plurality of BWPs (multiple activate BWP operation) semi-statically on the UE.

### <MAC CE>

Using the MAC CE, the base station may instruct the UE to activate one or a plurality of BWPs. For example, using higher layer signaling, with respect to the single active BWP index notification and multiple active BWP index notification, the base station configures a set of BWP notification field configurations on the UE.

As a set of BWP notification field configurations, with respect to the single active BWP index notification and multiple active BWP index notification, one set may be configured (e.g., see FIG. 5A), or a plurality of (e.g., 2) sets may be configured (e.g., see FIG. 6A).

Further, using the MAC CE, the base station may notify the UE of information (e.g., BWP index) on one or a plurality of BWPs to activate. In this case, using the MAC CE, the base station may notify the UE of whether to activate one BWP (single activate BWP operation) or to activate a plurality of BWPs (multiple activate BWP operation).

### <Timer>

In the multiple activate BWP operation (multiple activate BWP operation mode), by using a timer, control may be performed so as to fall back to the single activate BWP operation (single activate BWP operation mode).

In the case where DL BWP and UL BWP are paired (paired spectrum operation), when the UE detects DCI (e.g., DCI format 1_1) for indicating activation of one or a plurality of DL BWPs, the UE starts a timer with respect to each BWP except the default DL BWP. In this case, the UE may similarly control activation/deactivation of DL BWP and UL BWP.

In addition, in the case where DL BWP and UL BWP are not paired (unpaired spectrum operation), when the UE detects DCI (e.g., DCI format 1_1 or format 0_1) for indicating activation of one or a plurality of DL BWPs or UL BWPs, the UE starts a timer with respect to each BWP except the default DL BWP or default UL BWP. In this case, the UE may control activation/deactivation of DL BWP and UL BWP independently thereof.

In the case where the UE does not detect DCI that corresponds to the additionally activated BWP subsequently, the UE counts up (increments) the timer for each predetermined period. For example, in the case where the carrier frequency is 6 GHz or less, the UE counts up the timer every 1 ms. On the other hand, in the case where the carrier frequency is more than 6 GHz, the UE may count up the timer every 0.5 ms.

In the case where the timer is counted up to a predetermined value, the timer expires. With expiration of the timer, the UE activates the default BWP (switches from the multiple activate BWP operation mode to the single activate BWP operation mode). In addition, as the timer, the existing BWP-Inactivity Timer may be reused, or a new timer may be defined.

Thus, in the case of activating a plurality of BWPs, based on expiration of the timer, the BWP is deactivated, while corresponding to expiration of the timer, a predetermined BWP (e.g., default BWP) is activated, and it is thereby possible to flexibly change and control the BWP to activate corresponding to the communication circumstance. Further, by using the timer, also in the case of activating a plurality of BWPs, it is possible to activate without the base station separately indicating a BWP that is not used in communication for a predetermined period. Therefore, also in the case of activating a plurality of BWPs, it is possible to suppress increases in overhead of notification to the UE.

### Aspect 2

Aspect 2 is to configure UE capability information (UE capability) indicating whether or not to be able to activate a plurality of BWPs concurrently.

Also in the case of permitting concurrent activation of a plurality of BWPs, the case is considered where all UEs are not able to support activation of a plurality of BWPs. Therefore, the UE capability of activating the BWP is defined, and the UE may notify the base station.

For example, the UE may notify the base station of information about whether or not to support the operation (multiple active BWP operation) for activating a plurality of BWPs as the UE capability information.

Alternatively, the UE may notify the base station of information on the maximum number of concurrent activation-capable BWPs, as the UE capability information.

Alternatively, among concurrent activation-capable BWPs, the UE may notify the base station of information on the maximum number of BWPs to which different numerology is applicable, as the UE capability information.

Alternatively, the UE may notify the base station of information about whether or not to be able to dynamically switch activation of a plurality of BWPs as the UE capability information. For example, in the case where the UE is capable of switching from the single activate BWP operation (single activate BWP operation mode) to the multiple activate BWP operation (multiple activate BWP operation mode), the UE may notify the base station of such capability as the UE capability information.

Thus, by notifying the base station of the UE capability information about concurrent activation of a plurality of BWPs, the base station is capable of properly controlling the number of BWPs to activate and the like for each UE.

### Aspect 3

Aspect 3 describes control of Radio Link Monitoring (RLM) in the case of permitting activation of a plurality of BWPs.

In the existing LTE system (LTE Rel.8-13), monitoring (RLM: Radio Link Monitoring) of radio link quality is performed. When Radio Link Failure (RLF) is detected by RLM, the user terminal (UE: User Equipment) is required for re-establishment of RRC (Radio Resource Control) connection.

In the case of permitting activation (multiple activate BWP operation) of a plurality of BWPs, it is necessary to properly control RLM. One example of RLM control will be described below, in the case of activating a plurality of BWPs.

### <RLM Control 1>

In the case of activating a plurality of BWPs, it is configured to selectively perform RLM in a predetermined BWP (e.g., one fixed BWP or default BWP). In other words, in the case where a plurality of BWPs is concurrently activated, the BWP to perform RLM may be limited.

In the case where a plurality of BWPs is activated, RLM may be performed selectively on a predetermined BWP. The predetermined BWP may be notified beforehand from the base station to the UE using at least one of the downlink control information, MAC CE and higher layer signaling, or may be selected by the UE based on a predetermined condition (e.g., among activated BWPs, a BWP with a minimum index, etc.). Further, in some period, in the case where only one BWP is in an active state, it may be configured to perform RLM on the BWP.

Resources of a reference signal for RLM used in RLM may be configured on a predetermined BWP. The RLM-RS resource may be associated with resources and/or port for a synchronization signal block (SSB) or RS (CSI-RS: Channel State Information RS) for channel state measurement. In addition, the SSB may be called an SS/PBCH (Physical Broadcast Channel) block.

The RLM-RS may be at least one of a primary synchronization signal (PSS: Primary SS), secondary synchronization signal (SSS: Secondary SS), mobility reference signal (MRS: Mobility RS), CSI-RS, demodulation reference signal (DMRS: DeModulation Reference Signal), beam-specific signal and the like, or a signal (e.g., a signal configured by changing the density and/or periodicity) configured by extending and/or changing the aforementioned signal.

The UE may be configured for measurement using the RLM-RS resource with respect to the predetermined BWP, using higher layer signaling. Based on a measurement result in the RLM-RS resource, the UE configured for the measurement may determine whether the radio link is a synchronized state (IS: In-Sync) or an out of synchronization state (OOS: Out-Of-Sync).

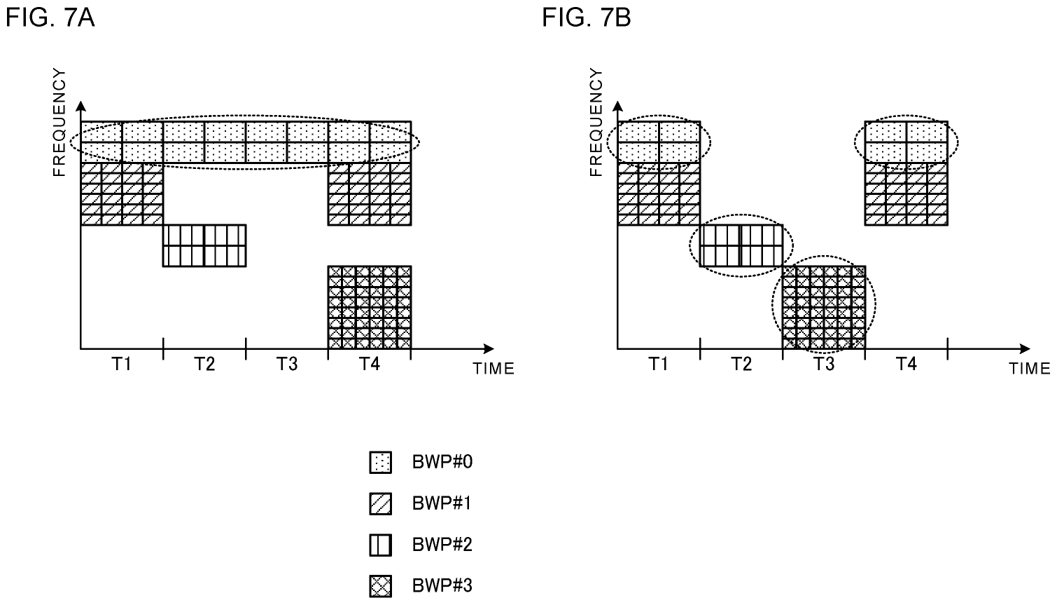

FIG. 7 shows one example of BWPs to activate in some period. FIG. 7A illustrates the case where BWP #0 and BWP #1 are activated in a first period T1, the BWP #0 and BWP #2 are activated in a second period T2, the BWP #0 is activated in a third period T3, and the BWP #0, BWP #2 and BWP #3 are activated in a fourth period T4. Herein, the case is shown where the BWP #0 is activated in all periods.

In FIG. 7A, the BWP #0 is configured as a predetermined BWP (fixed BWP or default BWP), and RLM is performed selectively on the BWP #0. The UE performs RLM on the BWP #0 to activate in each period (T1 to T4), and does not perform RLM on the other activated BWPs.

FIG. 7B illustrates the case where BWP #0 and BWP #1 are activated in a first period T1, BWP #2 is activated in a second period T2, BWP #3 is activated in a third period T3, and the BWP #0 and BWP #1 are activated in a fourth period T4. Herein, the case is shown where the BWP to activate in each period is dynamically varied.

FIG. 7B illustrates the case where a predetermined BWP (fixed BWP or default BWP) is varied for each period. For example, in each period, it may be configured to selectively perform. RLM on a BWP with a minimum. BWP index in activated BWPs. In this case, the UE performs RLM on the BWP #0 in the first period T1 and fourth period T4, performs RLM on the BWP #2 in the second period T2, and performs RLM on the BWP #3 in the third period T3.

Thus, also in the case of activating a plurality of BWPs, by performing RLM selectively on a part of BWPs among activated BWPs, it is possible to suppress increases in the load on the UE by omitting unnecessary RLM operation.

### <RLM Control 2>

In the case of activating a plurality of BWPs, it is configured to perform RLM on one or a plurality of BWPs. In other words, in the case where a plurality of BWPs is concurrently activated, it may be configured to perform RLM on at least one or more BWPs.

One or a plurality of BWPs to perform RLM may be configured for the UE from the base station, or based on a predetermined condition, may be selected by the UE. Further, the UE may perform RLM on all activated BWPs, or the total number of BWPs to concurrently perform RLM may be limited to a predetermined value or less.

Thus, by flexibly configuring the number of BWPs and/or BWP indexes to perform RLM, it is possible to flexibly control RLM.

### <Limitations on a Cell to Activate a Plurality of BWPs>

A cell to apply the multiple activate BWP operation may be limited to a secondary cell. In other words, it may be configured that activation of a plurality of BWPs is not performed in a predetermined cell (e.g., PCell, PSCell).

Ordinarily, RLM is performed in a predetermined cell (e.g., PCell, PSCell). Therefore, by controlling so as not to activate a plurality of BWPs in the predetermined cell, it is possible to suppress complexity of RLM operation in the predetermined cell.

### Aspect 4

Aspect 4 describes configuration of the control resource set (also called CORESET) in the case of permitting activation of a plurality of BWPs.

In the operation (single activate BWP operation mode) for activating one BWP, the predetermined number of (e.g., maximum 3) control resource sets is configured for each BWP. In each control resource set, UE-specific search space (USS) and/or common search space (CSS) is configured. As the common search space, one or a plurality of types may be configured.

For example, each BWP of the P cell may be provided with common search space for random access procedure (RACH: Random Access Channel Procedure). Similarly, each BWP of the P cell may be provided with common search space for fall back, common search space for paging or common search space for RMSI (Remaining Minimum System Information).

In the operation (multiple activate BWP operation mode) for activating a plurality of BWPs, it is necessary to properly control the control resource set for each BWP. Configuration of the control resource set and the like will be described below in the case of activating a plurality of BWPs.

### Configuration Example 1

In a configuration example 1, the control resource set is configured for each of a plurality of activated BWPs. Particularly, in the case of not supporting a configuration (also called cross BWP scheduling) where some BWP controls scheduling of another BWP among a plurality of BWPs, it is necessary to configure the control resource for each BWP. In addition, as the control resource set, the synchronization signal block (or, search space configuration (SS configuration)) may also be configured for each BWP.

Further, in the case where a plurality of BWPs is activated, it may be configured that the common search space (CSS) configured in the control resource set is configured only in the control resource set that corresponds to a predetermined BWP (e.g., fixed BWP or default BWP). By this means, the UE is required to perform monitoring of the DCI (CSS) transmitted in common to UEs only on the predetermined BWP, and is thereby capable of reducing loads on reception processing.

### Configuration Example 2

In a configuration example 2, the control resource set (e.g., CORESET configuration) is configured selectively for a predetermined BWP (e.g., fixed BWP or default BWP) among a plurality of activated BWPs. Particularly, in the case of supporting the configuration (also called cross BWP scheduling) where some BWP controls scheduling of another BWP among a plurality of BWPs, using the control resource set configured for the predetermined BWP, scheduling in another BWP may be controlled.

In addition, as the control resource set, the synchronization signal block (or, search space configuration (SS configuration)) may also be configured selectively for the predetermined BWP.

Thus, by making the configuration where the control resource set is configured only for the predetermined BWP without configuring for the other BWPs, the UE is enough to monitor the control resource set only in the predetermined BWP. By this means, it is possible to reduce loads on reception operation of the UE. In addition, the predetermined BWP may be one among a plurality of BWPs, or may be a part (a plurality) of the BWPs.

The control resource set (or, search space configuration) configured for the predetermined BWP may be associated with the corresponding BWP index. The UE may judge that the DCI included in the control resource set (or, search space configuration) detected in the predetermined BWP is DCI to the beforehand related BWP. In addition, the DCI may include information indicative of the BWP to which the DCI corresponds.

For example, each control resource set (or, search space configuration) may be related to a particular BWP.

Alternatively, each control resource set (or, search space configuration) may be associated with a plurality of BWP indexes (different BWP indexes), and a notification field to indicate the corresponding BWP index may be configured in each DCI format.

Thus, in the case of configuring the control resource set only for the predetermined BWP, by associating the control resource set (or, search space configuration) with the BWP to control, it is possible to properly perform cross BWP scheduling.

### (Radio Communication System)

A configuration of a radio communication system according to one Embodiment of the present disclosure will be described below. In the radio communication system, communication is performed by using any of the radio communication methods according to above-mentioned each Embodiment of the disclosure or combination thereof.

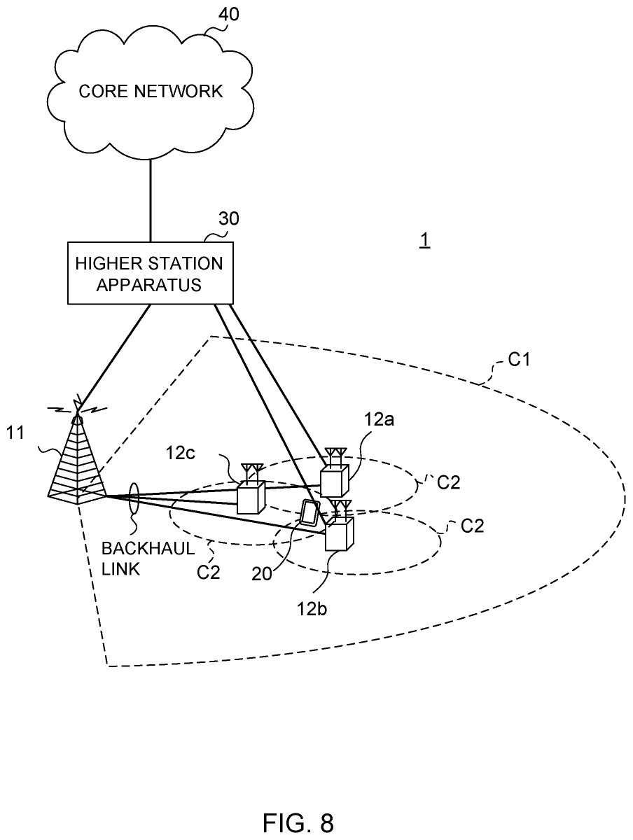

FIG. 8 is a diagram showing one example of a schematic configuration of the radio communication system according to one Embodiment of the present invention. In the radio communication system 1, it is possible to apply carrier aggregation (CA) to aggregate a plurality of base frequency blocks (component carriers) with a system bandwidth (e.g., 20 MHz) of the LTE system as one unit and/or dual connectivity (DC).

In addition, the radio communication system 1 may be called LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), NR (New Radio), FRA (Future Radio Access), New-RAT (Radio Access Technology) and the like, or may be called the system to actualize each system described above.

The radio communication system 1 is provided with a radio base station 11 for forming a macrocell C1 with relatively wide coverage, and radio base stations 12 (12a to 12c) disposed inside the macrocell C1 to form small cells C2 narrower than the macrocell C1. Further, a user terminal 20 is disposed in the macrocell C1 and each of the small cells C2. The arrangement, numbers and the like of each cell and user terminal 20 are not limited to the aspect shown in the figure.

The user terminal 20 is capable of connecting to both the radio base station 11 and the radio base station 12. The user terminal 20 is assumed to concurrently use the macrocell C1 and small cell C2 using CA or DC. Further, the user terminal 20 may apply CA or DC using a plurality of cells (CCs).

The user terminal 20 and radio base station 11 are capable of communicating with each other using carriers (also called the existing carrier, legacy carrier and the like) with a narrow bandwidth in a relatively low frequency band (e.g., 2 GHz). On the other hand, the user terminal 20 and radio base station 12 may use carriers with a wide bandwidth in a relatively high frequency band (e.g., 3.5 GHz, 5 GHz, etc.), or may use the same carrier as in the radio base station 11. In addition, the configuration of the frequency band used in each radio base station is not limited thereto.

Further, in each cell, the user terminal 20 is capable of performing communication using Time Division Duplex (TDD) and/or Frequency Division Duplex (FDD). Furthermore, in each cell (carrier), single numerology may be applied, or a plurality of different types of numerology may be applied.

The numerology may be a communication parameter applied to transmission and/or reception of some signal and/or a channel, and for example, may indicate at least one of subcarrier spacing, bandwidth, symbol length, cyclic prefix length, subframe length, TTI length, the number of symbols per TTI, radio frame configuration, particular filtering processing performed in the frequency domain by a transmitter/receiver, particular windowing processing performed in the time domain by a transmitter/receiver and the like. Forex ample, for some physical channel, in the case where the subcarrier spacing of constituting OFDM symbols is different and/or the case where the number of OFDM symbols is different, the case may refer to that the numerology is different.

The radio base station 11 and radio base station 12 (or, two radio base stations 12) may be connected by cable (e.g., optical fiber in conformity with CPRI (Common Public Radio Interface), X2 interface, etc.), or radio.

The radio base station 11 and each of the radio base stations 12 are respectively connected to a higher station apparatus 30, and are connected to a core network 40 via the higher station apparatus 30. In addition, for example, the higher station apparatus 30 includes an access gateway apparatus, Radio Network Controller (RNC), Mobility Management Entity (MME) and the like, but is not limited thereto. Further, each of the radio base stations 12 may be connected to the higher station apparatus 30 via the radio base station 11.

In addition, the radio base station 11 is a radio base station having relatively wide coverage, and may be called a macro base station, collection node, eNB (eNodeB), transmission and reception point and the like. Further, the radio base station 12 is a radio base station having local coverage, and may be called a small base station, micro-base station, pico-base station, femto-base station, HeNB (Home eNodeB), RRH (Remote Radio Head), transmission and reception point and the like. Hereinafter, in the case of not distinguishing between the radio base stations 11 and 12, the stations are collectively called a radio base station 10.

Each user terminal 20 is a terminal supporting various communication schemes such as LTE and LTE-A, and may include a fixed communication terminal (fixed station), as well as the mobile communication terminal (mobile station).

In the radio communication system 1, as radio access schemes, Orthogonal Frequency Division Multiple Access (OFDMA) is applied on downlink, and Single Carrier Frequency Division Multiple Access (SC-FDMA) and/or OFDMA is applied on uplink.

OFDMA is a multicarrier transmission scheme for dividing a frequency band into a plurality of narrow frequency bands (subcarriers), and mapping data to each subcarrier to perform communication. SC-FDMA is a single-carrier transmission scheme for dividing a system bandwidth into bands comprised of one or contiguous resource blocks for each terminal so that a plurality of terminals uses mutually different bands, and thereby reducing interference among terminals. In addition, uplink and downlink radio access schemes are not limited to the combination of the schemes, and another radio access scheme may be used.

As downlink channels, in the radio communication system 1 are used a downlink shared channel (PDSCH: Physical Downlink Shared Channel) shared by user terminals 20, broadcast channel (PBCH: Physical Broadcast Channel), downlink L1/L2 control channels and the like. User data, higher layer control information, SIB (System Information Block) and the like are transmitted on the PDSCH. Further, MIB (Master Information Block) is transmitted on the PBCH.

The downlink L1/L2 control channel includes PDCCH (Physical Downlink Control Channel), EPDCCH (Enhanced Physical Downlink Control Channel), PCFICH (Physical Control Format Indicator Channel), PHICH (Physical Hybrid-ARQ Indicator Channel) and the like. The downlink control information (DCI) including scheduling information of the PDSCH and/or PUSCH and the like is transmitted on the PDCCH.

In addition, scheduling information may be notified by DCI. For example, DCI for scheduling DL data reception may be called a DL assignment, and DCI for scheduling UL data transmission may be called a UL grant.

The number of OFDM symbols used in the PDCCH is transmitted on the PCFICH. Receipt confirmation information (e.g., also referred to as retransmission control information, HARQ-ACK, ACK/NACK, etc.) of HARQ (Hybrid Automatic Repeat reQuest) for the PUSCH is transmitted on the PHICH. The EPDCCH is frequency division multiplexed with the PDSCH (downlink shared data channel) to be used in transmitting the DCI and the like as the PDCCH.

As uplink channels, in the radio communication system 1 are used an uplink shared channel (PUSCH: Physical Uplink Shared Channel) shared by user terminals 20, uplink control channel (PUCCH: Physical Uplink Control Channel), random access channel (PRACH: Physical Random Access Channel) and the like. User data, higher layer control information and the like is transmitted on the PUSCH. Further, radio quality information (CQI: Channel Quality Indicator) of downlink, receipt confirmation information, scheduling request (SR) and the like are transmitted on the PUCCH. A random access preamble to establish connection with the cell is transmitted on the PRACH.

As downlink reference signals, in the radio communication system 1 are transmitted Cell-specific Reference Signal (CRS), Channel State Information-Reference Signal (CSI-RS), Demodulation Reference Signal (DMRS: Demodulation Reference Signal), Positioning Reference Signal (PRS) and the like. Further, as uplink reference signals, in the radio communication system 1 are transmitted Sounding Reference Signal (SRS), Demodulation Reference Signal (DMRS) and the like. In addition, the DMRS may be called UE-specific Reference Signal. Further, the transmitted reference signals are not limited thereto.

### (Radio Base Station)

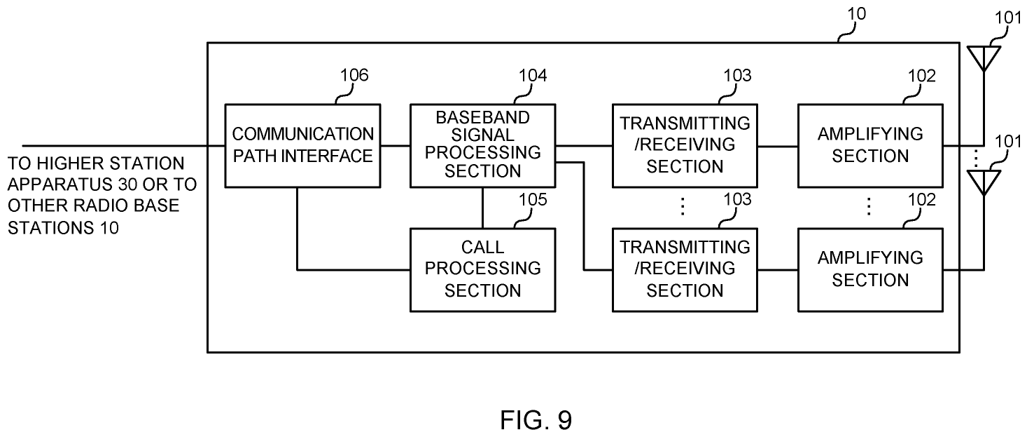

FIG. 9 is a diagram showing one example of an entire configuration of the radio base station according to one Embodiment. The radio base station 10 is provided with a plurality of transmitting/receiving antennas 101, amplifying sections 102, transmitting/receiving sections 103, baseband signal processing section 104, call processing section 105, and communication path interface 106. In addition, with respect to each of the transmitting/receiving antenna 101, amplifying section 102, and transmitting/receiving section 103, the radio base station may be configured to include at least one or more.

User data to transmit to the user terminal 20 from the radio base station 10 on downlink is input to the baseband signal processing section 104 from the higher station apparatus 30 via the communication path interface 106.

The baseband signal processing section 104 performs, on the user data, transmission processing such as processing of PDCP (Packet Data Convergence Protocol) layer, segmentation and concatenation of the user data, transmission processing of RLC (Radio Link Control) layer such as RLC retransmission control, MAC (Medium Access Control) retransmission control (e.g., transmission processing of HARQ), scheduling, transmission format selection, channel coding, Inverse Fast Fourier Transform (IFFT) processing, and precoding processing to transfer to the transmitting/receiving sections 103. Further, also concerning a downlink control signal, the section 104 performs transmission processing such as channel coding and Inverse Fast Fourier Transform on the signal to transfer to the transmitting/receiving sections 103.

Each of the transmitting/receiving sections 103 converts the baseband signal, which is subjected to pre co di ng for each antenna and is output from the baseband signal processing section 104, into a signal with a radio frequency band to transmit. The radio-frequency signal subjected to frequency conversion in the transmitting/receiving section 103 is amplified in the amplifying section 102, and is transmitted from the transmitting/receiving antenna 101. The transmitting/receiving section 103 is capable of being comprised of a transmitter/receiver, transmitting/receiving circuit or transmitting/receiving apparatus explained based on common recognition in the technical field according to the present disclosure. In addition, the transmitting/receiving section 103 may be comprised as an integrated transmitting/receiving section, or may be comprised of a transmitting section and receiving section.

On the other hand, for uplink signals, radio-frequency signals received in the transmitting/receiving antennas 101 are amplified in the amplifying sections 102. The transmitting/receiving section 103 receives the uplink signal amplified in the amplifying section 102. The transmitting/receiving section 103 performs frequency conversion on the received signal into a baseband signal to output to the baseband signal processing section 104.

For user data included in the input uplink signal, the baseband signal processing section 104 performs Fast Fourier Transform (FFT) processing, Inverse Discrete Fourier Transform (IDFT) processing, error correcting decoding, reception processing of MAC retransmission control, and reception processing of RLC layer and PDCP layer to transfer to the higher station apparatus 30 via the communication path interface 106. The call processing section 105 performs call processing (configuration, release and the like) of a communication channel, state management of the radio base station 10, management of radio resources and the like.

The communication path interface 106 transmits and receives signals to/from the higher station apparatus 30 via a predetermined interface. Further, the communication path interface 106 may transmit and receive signals (backhaul signaling) to/from another radio base station 10 via an inter-base station interface (e.g., optical fiber in conformity with CPRI (Common Public Radio Interface), X2 interface).

The transmitting/receiving section 103 transmits downlink control information for indicating activation of a predetermined BWP among one or more partial frequency bands (BWP: Bandwidth Part) configured within a carrier. Further, the transmitting/receiving section 103 performs transmission and/or reception using a plurality of activated BWPs.

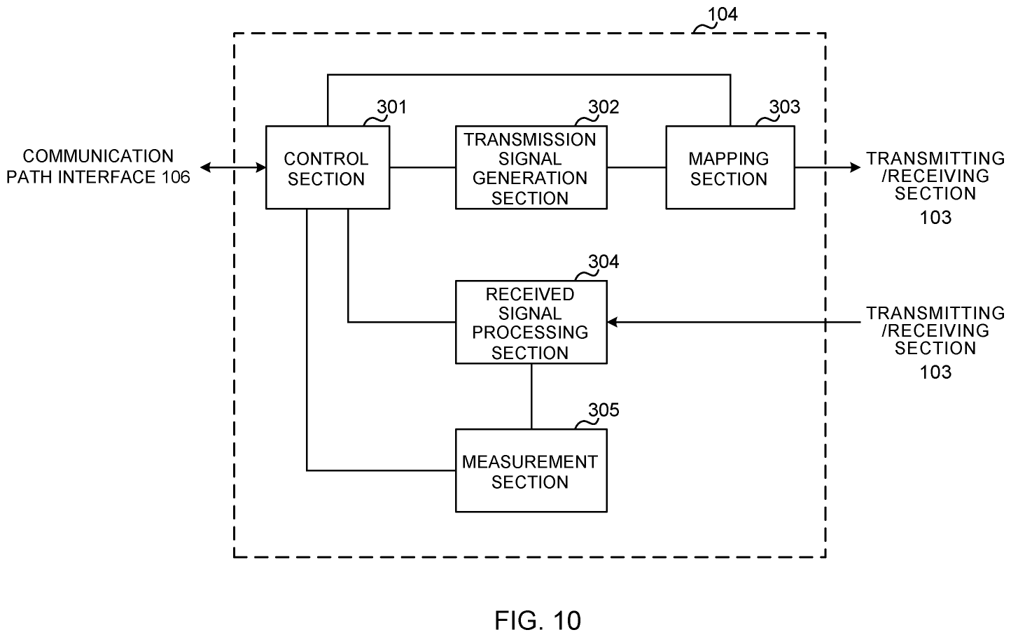

FIG. 10 is a diagram showing one example of a function configuration of the radio base station according to one Embodiment. In addition, this example mainly illustrates function blocks of a characteristic portion in this Embodiment, and the radio base station 10 may be assumed to also have other function blocks required for radio communication.

The baseband signal processing section 104 is provided with at least a control section (scheduler) 301, transmission signal generating section 302, mapping section 303, received signal processing section 304, and measurement section 305. In addition, these components are essentially included in the radio base station 10, and a part or the whole of the components may not be included in the baseband signal processing section 104.

The control section (scheduler) 301 performs control of the entire radio base station 10. The control section 301 is capable of being comprised of a controller, control circuit or control apparatus explained based on the common recognition in the technical field according to the present disclosure.

For example, the control section 301 controls generation of signals in the transmission signal generating section 302, allocation of signals in the mapping section 303 and the like. Further, the control section 301 controls reception processing of signals in the received signal processing section 304, measurement of signals in the measurement section 305 and the like.

The control section 301 controls scheduling (e.g., resource allocation) of system information, downlink data signal (e.g., signal transmitted on the PDSCH), and downlink control signal (e.g., signal transmitted on the PDCCH and/or EPDCCH, receipt conformation information, etc.). Further, based on a result obtained by determining the necessity of retransmission control to an uplink data signal, and the like, the control section 301 controls generation of the downlink control signal, downlink data signal and the like.

The control section 301 controls scheduling of synchronization signals (e.g., PSS (Primary Synchronization Signal)/SSS (Secondary Synchronization Signal)), downlink reference signals (e.g., CRS, CSI-RS, DMRS) and the like.

The control section 301 controls scheduling of the uplink data signal (e.g., signal transmitted on the PUSCH), uplink control signal (e.g., signal transmitted on the PUCCH and/or PUSCH, receipt confirmation information, etc.), random access preamble (e.g., signal transmitted on the PRACH), uplink reference signal and the like.

The control section 301 controls activation of one or a plurality of BWPs using at least one of the downlink control information, MAC control information and higher layer signaling. Further, in the case where a timer configured for one or more activated BWPs expires, the control section 301 may control to activate the default BWP.

Further, the control section 301 may control to activate a plurality of BWPs only in a predetermined cell. Furthermore, in the case where a plurality of BWPs is activated, the control section 301 may control to configure at least one of the control resource set and search space configuration for a particular BWP among the plurality of BWPs.

Based on instructions from the control section 301, the transmission signal generating section 302 generates downlink signals (downlink control signal, downlink data signal, downlink reference signal, etc.) to output to the mapping section 303. The transmission signal generating section 302 is capable of being comprised of a signal generator, signal generating circuit or signal generating apparatus explained based on the common recognition in the technical field according to the present disclosure.

For example, based on instructions from the control section 301, the transmission signal generating section 302 generates a DL assignment to notify of assignment information of downlink data and/or UL grant to notify of assignment information of uplink data. Each of the DL assignment and UL grant is the DCI and conforms to a DCI format. Further, the downlink data signal is subjected to coding processing and modulation processing, according to a coding rate, modulation scheme and the like determined based on the channel state information (CSI) from each user terminal 20 and the like.

Based on instructions from the control section 301, the mapping section 303 maps the downlink signal generated in the transmission signal generating section 302 to predetermined radio resources to output to the transmitting/receiving section 103. The mapping section 303 is capable of being comprised of a mapper, mapping circuit or mapping apparatus explained based on the common recognition in the technical field according to the present disclosure.

The received signal processing section 304 performs reception processing (e.g., demapping, demodulation, decoding, etc.) on the received signal input from the transmitting/receiving section 103. Herein, for example, the received signal is the uplink signal (uplink control signal, uplink data signal, uplink reference signal, etc.) transmitted from the user terminal 20. The received signal processing section 304 is capable of being comprised of a signal processor, signal processing circuit or signal processing apparatus explained based on the common recognition in the technical field according to the present disclosure.

The received signal processing section 304 outputs the information decoded by the reception processing to the control section 301. For example, in the case of receiving the PUCCH including HARQ-ACK, the section 304 outputs the HARQ-ACK to the control section 301. Further, the received signal processing section 304 outputs the received signal and/or signal subjected to the reception processing to the measurement section 305.

The measurement section 305 performs measurement on the received signal. The measurement section 305 is capable of being comprised of a measurement device, measurement circuit or measurement apparatus explained based on the common recognition in the technical field according to the present disclosure.

For example, based on the received signal, the measurement section 305 may perform RRM (Radio Resource Management) measurement, CSI (Channel State Information) measurement and the like. The measurement section 305 may measure received power (e.g., RSRP (Reference Signal Received Power)), received quality (e.g., RSRQ (Reference Signal Received Quality), SINR (Signal to Interference plus Noise Ratio), SNR (Signal to Noise Ratio)), signal strength (e.g., RSSI (Received Signal Strength Indicator)), propagation path information (e.g., CSI) and the like. The measurement result may be output to the control section 301.

### (User Terminal)

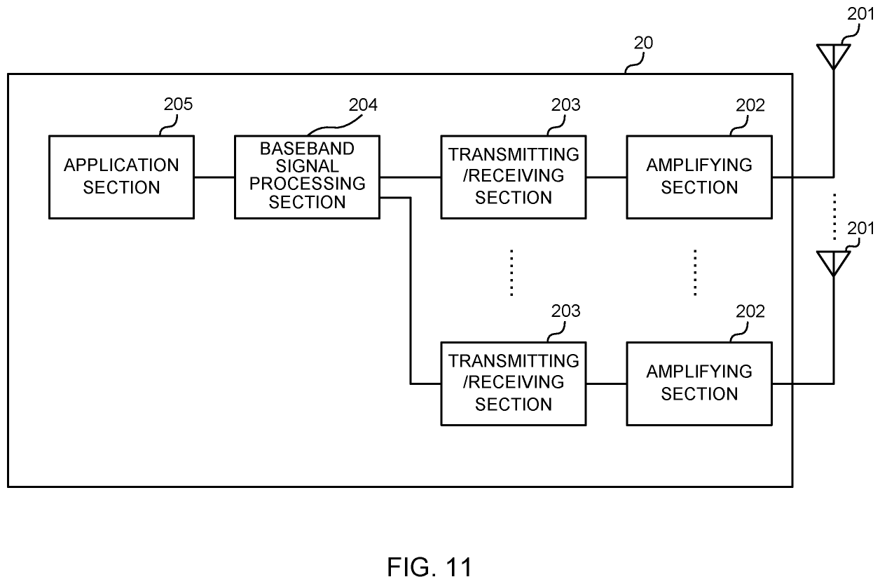

FIG. 11 is a diagram showing one example of an entire configuration of the user terminal according to one Embodiment. The user terminal 20 is provided with a plurality of transmitting/receiving antennas 201, amplifying sections 202, transmitting/receiving sections 203, baseband signal processing section 204, and application section 205. In addition, with respect to each of the transmitting/receiving antenna 201, amplifying section 202, and transmitting/receiving section 203, the user terminal may be configured to include at least one or more.

Radio-frequency signals received in the transmitting/receiving antennas 201 are respectively amplified in the amplifying sections 202. Each of the transmitting/receiving sections 203 receives the downlink signal amplified in the amplifying section 202. The transmitting/receiving section 203 performs frequency conversion on the received signal into a baseband signal to output to the baseband signal processing section 204. The transmitting/receiving section 203 is capable of being comprised of a transmitter/receiver, transmitting/receiving circuit or transmitting/receiving apparatus explained based on the common recognition in the technical field according to the present disclosure. In addition, the transmitting/receiving section 203 may be comprised as an integrated transmitting/receiving section, or may be comprised of a transmitting section and receiving section.

The baseband signal processing section 204 performs FFT processing, error correcting decoding, reception processing of retransmission control and the like on the input baseband signal. User data on downlink is transferred to the application section 205. The application section 205 performs processing concerning layers higher than the physical layer and MAC layer, and the like. Further, among the downlink data, broadcast information may also be transferred to the application section 205.

On the other hand, for user data on uplink, the data is input to the baseband signal processing section 204 from the application section 205. The baseband signal processing section 204 performs transmission processing of retransmission control (e.g., transmission processing of HARQ), channel coding, precoding, Discrete Fourier Transform (DFT) processing, IFFT processing and the like to transfer to each of the transmitting/receiving sections 203.

Each of the transmitting/receiving sections 203 converts the baseband signal output from the baseband signal processing section 204 into a signal with a radio frequency band to transmit. The radio-frequency signals subjected to frequency conversion in the transmitting/receiving sections 203 are amplified in the amplifying sections 202, and are transmitted from the transmitting/receiving antennas 201, respectively.

The transmitting/receiving section 203 receives the downlink control information for indicating activation of a predetermined BWP among one or more partial frequency bands (BWP: Bandwidth Part) configured within a carrier. Further, the transmitting/receiving section 203 performs transmission and/or reception using a plurality of activated BWPs.

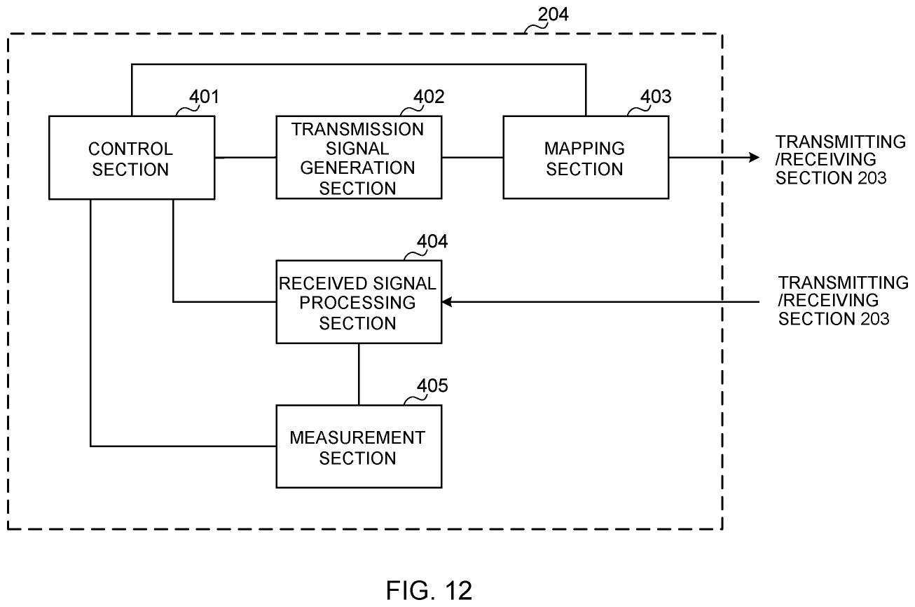

FIG. 12 is a diagram showing one example of a function configuration of the user terminal according to one Embodiment. In addition, this example mainly illustrates function blocks of a characteristic portion in this Embodiment, and the user terminal 20 may be assumed to also have other function blocks required for radio communication.

The baseband signal processing section 204 that the user terminal 20 has is provided with at least a control section 401, transmission signal generating section 402, mapping section 403, received signal processing section 404, and measurement section 405. In addition, these components are essentially included in the user terminal 20, and a part or the whole of the components may not be included in the baseband signal processing section 204.

The control section 401 performs control of the entire user terminal 20. The control section 401 is capable of being comprised of a controller, control circuit or control apparatus explained based on the common recognition in the technical field according to the present disclosure.

For example, the control section 401 controls generation of signals in the transmission signal generating section 402, allocation of signals in the mapping section 403 and the like. Further, the control section 401 controls reception processing of signals in the received signal processing section 404, measurement of signals in the measurement section 405 and the like.

The control section 401 acquires the downlink control signal and downlink data signal transmitted from the radio base station 10, from the received signal processing section 404. Based on the downlink control signal and/or a result obtained by determining the necessity of retransmission control to the downlink data signal, and the like, the control section 401 controls generation of the uplink control signal and/or uplink data signal.

The control section 401 controls activation of one or a plurality of BWPs based on at least one of the downlink control information, MAC control information and higher layer signaling.

Further, in the case where a timer configured for one or more activated BWPs expires, the control section 401 may control to activate the default BWP. Furthermore, in the case where a plurality of BWPs is activated, the control section 401 may control to perform monitoring selectively on the predetermined BWP.

Moreover, the control section 401 may control to activate a plurality of BWPs only in a predetermined cell. Further, in the case where a plurality of BWPs is activated, the control section 401 may control reception processing, while assuming that at least one of the control resource set and search space configuration is configured for a particular BWP among the plurality of BWPs.

Based on instructions from the control section 401, the transmission signal generating section 402 generates uplink signals (uplink control signal, uplink data signal, uplink reference signal, etc.) to output to the mapping section 403. The transmission signal generating section 402 is capable of being comprised of a signal generator, signal generating circuit or signal generating apparatus explained based on the common recognition in the technical field according to the present disclosure.

For example, based on instructions from the control section 401, the transmission signal generating section 402 generates the uplink control signal about receipt confirmation information, channel state information (CSI) and the like. Further, based on instructions from the control section 401, the transmission signal generating section 402 generates the uplink data signal. For example, when the downlink control signal notified from the radio base station 10 includes the UL grant, the transmission signal generating section 402 is instructed to generate the uplink data signal from the control section 401.

Based on instructions from the control section 401, the mapping section 403 maps the uplink signal generated in the transmission signal generating section 402 to radio resources to output to the transmitting/receiving section 203. The mapping section 403 is capable of being comprised of a mapper, mapping circuit or mapping apparatus explained based on the common recognition in the technical field according to the present disclosure.

The received signal processing section 404 performs reception processing (e.g. demapping, demodulation, decoding, etc.) on the received signal input from the transmitting/receiving section 203. Herein, for example, the received signal is the downlink signal (downlink control signal, downlink data signal, downlink reference signal, etc.) transmitted from the radio base station 10. The received signal processing section 404 is capable of being comprised of a signal processor, signal processing circuit or signal processing apparatus explained based on the common recognition in the technical field according to the present disclosure. Further, the received signal processing section 404 is capable of constituting the receiving section according to the present disclosure.

The received signal processing section 404 outputs the information decoded by the reception processing to the control section 401. For example, the received signal processing section 404 outputs the broadcast information, system information, RRC signaling, DCI and the like to the control section 401. Further, the received signal processing section 404 outputs the received signal and/or signal subjected to the reception processing to the measurement section 405.

The measurement section 405 performs measurement on the received signal. The measurement section 405 is capable of being comprised of a measurement device, measurement circuit or measurement apparatus explained based on the common recognition in the technical field according to the present disclosure.

For example, based on the received signal, the measurement section 405 may perform RRM measurement, CSI measurement and the like. The measurement section 405 may measure received power (e.g., RSRP), received quality (e.g., RSRQ, SINR, SNR), signal strength (e.g., RSSI), propagation path information (e.g., CSI) and the like. The measurement result may be output to the control section 401.

### (Hardware Configuration)

In addition, the block diagrams used in explanation of the above-mentioned Embodiment show blocks on a function-by-function basis. These function blocks (configuration sections) are actualized by any combination of hardware and/or software. Further, the means for actualizing each function block is not limited particularly. In other words, each function block may be actualized using a single apparatus combined physically and/or logically, or two or more apparatuses that are separated physically and/or logically are connected directly and/or indirectly (e.g., using cable and/or radio), and each function block may be actualized using a plurality of these apparatuses.

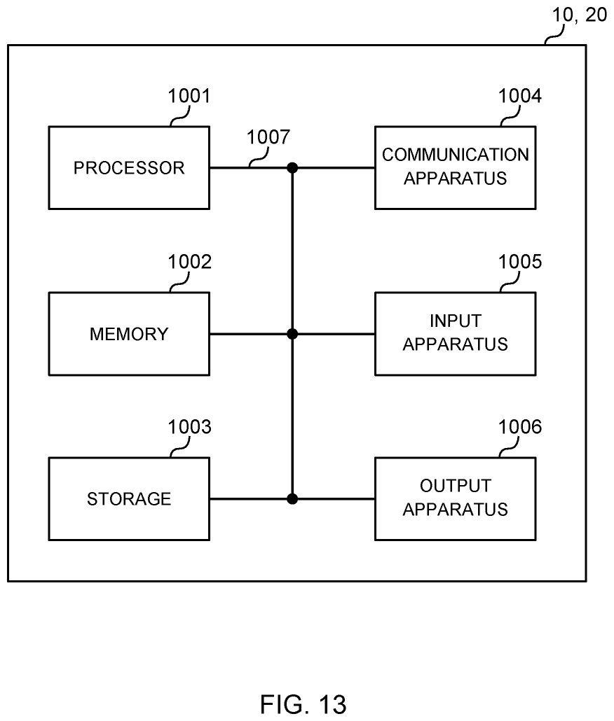

For example, each of the radio base station, user terminal and the like in one Embodiment of the present disclosure may function as a computer that performs the processing of the radio communication method of the disclosure. FIG. 13 is a diagram showing one example of a hardware configuration of each of the radio base station and user terminal according to one Embodiment. Each of the radio base station 10 and user terminal 20 as described above may be physically configured as a computer apparatus including a processor 1001, memory 1002, storage 1003, communication apparatus 1004, input apparatus 1005, output apparatus 1006, bus 1007 and the like.

In addition, in the following description, it is possible to replace the letter of “apparatus” with a circuit, device, unit and the like to read. With respect to each apparatus shown in the figure, the hardware configuration of each of the radio base station 10 and the user terminal 20 may be configured so as to include one or a plurality of apparatuses, or may be configured without including a part of apparatuses.

For example, a single processor 1001 is shown in the figure, but a plurality of processors may exist. Further, the processing may be executed by a single processor, or may be executed by one or more processors at the same time, sequentially or using another technique. In addition, the processor 1001 may be implemented on one or more chips.

For example, each function in the radio base station 10 and user terminal 20 is actualized in a manner such that predetermined software (program) is read on the hardware of the processor 1001, memory 1002 and the like, and that the processor 1001 thereby performs computations, and controls communication via the communication apparatus 1004, and read and/or write of data in the memory 1002 and storage 1003.

For example, the processor 1001 operates an operating system to control the entire computer. The processor 1001 may be comprised of a Central Processing Unit (CPU) including interfaces with peripheral apparatuses, control apparatus, computation apparatus, register and the like. For example, the above-mentioned baseband signal processing section 104 (204), call processing section 105 and the like may be actualized by the processor 1001.

Further, the processor 1001 reads the program (program code), software module, data and the like on the memory 1002 from the storage 1003 and/or the communication apparatus 1004, and according thereto, executes various kinds of processing. Used as the program is a program that causes the computer to execute at least apart of operation described in the above-mentioned Embodiment. For example, the control section 401 of the user terminal 20 may be actualized by a control program stored in the memory 1002 to operate in the processor 1001, and the other function blocks may be actualized similarly.

The memory 1002 is a computer-readable storage medium, and for example, may be comprised of at least one of ROM (Read Only Memory), EPROM (Erasable Programmable ROM), EEPROM (Electrically EPROM), RAM (Random Access Memory) and other proper storage media. The memory 1002 may be called the register, cache, main memory (main storage apparatus) and the like. The memory 1002 is capable of storing the program (program code), software module and the like executable to implement the radio communication method according to one Embodiment.

The storage 1003 is a computer-readable storage medium, and for example, may be comprised of at least one of a flexible disk, floppy (Registered Trademark) disk, magneto-optical disk (e.g., compact disk (CD-ROM (Compact Disc ROM), etc.), digital multi-purpose disk, Blu-ray (Registered Trademark) disk), removable disk, hard disk drive, smart card, flash memory device (e.g., card, stick, key drive), magnetic stripe, database, server and other proper storage media. The storage 1003 may be called an auxiliary storage apparatus.

The communication apparatus 1004 is hardware communication between computers via a wired and/or wireless network, and for example, is also referred to as a network device, network controller, network card, communication module and the like. For example, in order to actualize Frequency Division Duplex (FDD) and/or Time Division Duplex (TDD), the communication apparatus 1004 may be comprised by including a high-frequency switch, duplexer, filter, frequency synthesizer and the like. For example, the transmitting/receiving antenna 101 (201), amplifying section 102 (202), transmitting/receiving section 103 (203), communication path interface 106 and the like as described above may be actualized by the communication apparatus 1004.

The input apparatus 1005 is an input device (e.g., keyboard, mouse, microphone, switch, button, sensor, etc.) that receives input from the outside. The output apparatus 1006 is an output device (e.g., display, speaker, LED (Light Emitting Diode) lamp, etc.) that performs output to the outside. In addition, the input apparatus 1005 and output apparatus 1006 may be an integrated configuration (e.g., touch panel).

Further, each apparatus of the processor 1001, memory 1002 and the like is connected on the bus 1007 to communicate information. The bus 1007 may be configured using a single bus, or may be configured using different buses between apparatuses.

Furthermore, each of the radio base station 10 and user terminal 20 may be configured by including hardware such as a microprocessor, Digital Signal Processor (DSP), ASIC (Application Specific Integrated Circuit), PLD (Programmable Logic Device), and FPGA (Field Programmable Gate Array), or a part or the whole of each function block may be actualized using the hardware. For example, the processor 1001 may be implemented using at least one of the hardware.

### Modification

In addition, the term explained in the present Description and/or the term required to understand the present Description may be replaced with a term having the same or similar meaning. For example, the channel and/or the symbol may be a signal (signaling). Further, the signal may be a message. The reference signal is capable of being abbreviated as RS (Reference Signal), and according to the standard to apply, may be called a pilot, pilot signal and the like. Furthermore, the component carrier (CC) may be called a cell, frequency carrier, carrier frequency and the like.

Further, the radio frame may be comprised of one or a plurality of frames in the time domain. The one or each of the plurality of frames constituting the radio frame may be called a subframe. Furthermore, the subframe may be comprised of one or a plurality of slots in the time domain. The subframe may be a fixed time length (e.g., 1 ms) that is not dependent on numerology.

Furthermore, the slot may be comprised of one or a plurality of symbols (OFDM (Orthogonal Frequency Division Multiplexing) symbols, SC-FDMA (Single Carrier Frequency Division Multiple Access) symbols and the like) in the time domain. Still furthermore, the slot may a time unit based on numerology. Moreover, the slot may include a plurality of mini-slots. Each mini-slot may be comprised of one or a plurality of symbols in the time domain. Further, the mini-slot may be called a subslot.

Each of the radio frame, subframe, slot, mini-slot and symbol represents a time unit in transmitting a signal. For the radio frame, subframe, slot, mini-slot and symbol, another name corresponding to each of them may be used. For example, one subframe may be called Transmission Time Interval (TTI), a plurality of contiguous subframes may be called TTI, or one slot or one mini-slot may be called TTI. In other words, the subframe and/or TTI may be the subframe (1 ms) in existing LTE, may be a frame (e.g., 1 to 13 symbols) shorter than 1 ms, or may be a frame longer than 1 ms. In addition, instead of the subframe, the unit representing the TTI may be called the slot, mini-slot and the like.

Herein, for example, the TTI refers to a minimum time unit of scheduling in radio communication. For example, in the LTE system, the radio base station performs scheduling for allocating radio resources (frequency bandwidth, transmit power and the like capable of being used in each user terminal) to each user terminal in a TTI unit. In addition, the definition of the TTI is not limited thereto.

The TTI may be a transmission time unit of a data packet (transport block) subjected to channel coding, code block and/or codeword, or may be a processing unit of scheduling, link adaptation and the like. In addition, when the TTI is given, a time segment (e.g., the number of symbols) to which the transport block, code block and/or codeword is actually mapped may be shorter than the TTI.

In addition, when one slot or one mini-slot is called the TTI, one or more TTIs (i.e., one or more slots, or one or more mini-slots) may be the minimum time unit of scheduling. Further, the number of slots (the number of mini-slots) constituting the minimum time unit of scheduling may be controlled.

The TTI having a time length of 1 ms may be called ordinary TTI (TTI in LTE Rel.8-12), normal TTI, long TTI, ordinary subframe, normal subframe, long subframe or the like. The TTI shorter than the ordinary TTI may be called shortened TTI, short TTI, partial or fractional TTI, shortened subframe, short subframe, mini-slot, subslot or the like.

In addition, the long TTI (e.g., ordinary TTI, subframe, etc.) may be read with TTI having a time length exceeding 1 ms, and the short TTI (e.g., shortened TTI, etc.) may be read with TTI having a TTI length of 1 ms or more and less than the TTI length of the long TTI.

The resource block (RB) is a resource allocation unit in the time domain and frequency domain, and may include one or a plurality of contiguous subcarriers in the frequency domain. Further, the RB may include one or a plurality of symbols in the time domain, and may be a length of 1 slot, 1 mini-slot, 1 subcarrier, or 1 TTI. Each of 1 TTI and 1 subframe may be comprised of one or a plurality of resource blocks. In addition, one or a plurality of RBs may be called a physical resource block (PRB: Physical RB), subcarrier group (SCG: Sub-Carrier Group), resource element group (REG), PRB pair, RB pair and the like.

Further, the resource block may be comprised of one or a plurality of resource elements (RE: Resource Element). For example, 1 RE may be a radio resource region of 1 subcarrier and 1 symbol.

In addition, structures of the above-mentioned radio frame, subframe, slot, mini-slot, symbol and the like are only illustrative. For example, it is possible to modify, in various manners, configurations of the number of subframes included in the radio frame, the number of slots per subframe or radio frame, the number of mini-slots included in the slot, the numbers of symbols and RBs included in the slot or mini-slot, the number of subcarriers included in the RB, the number of symbols within the TTI, the symbol length, the cyclic prefix (CP) length and the like.

Further, the information, parameter and the like explained in the present Description may be expressed using an absolute value, may be expressed using a relative value from a predetermined value, or may be expressed using another corresponding information. For example, the radio resource may be indicated by a predetermined index.

The names used in the parameter and the like in the present Description are not restrictive names in any respects. For example, it is possible to identify various channels (PUCCH (Physical Uplink Control Channel), PDCCH (Physical Downlink Control Channel) and the like) and information elements, by any suitable names, and therefore, various names assigned to these various channels and information elements are not restrictive names in any respects.

The information, signal and the like explained in the present Description may be represented by using any of various different techniques. For example, the data, order, command, information, signal, bit, symbol, chip and the like capable of being described over the entire above-mentioned explanation may be represented by voltage, current, electromagnetic wave, magnetic field or magnetic particle, optical field or photon, or any combination thereof.

Further, the information, signal and the like are capable of being output from a higher layer to a lower layer, and/or from the lower layer to the higher layer. The information, signal and the like may be input and output via a plurality of network nodes.

The input/output information, signal and the like may be stored in a particular place (e.g., memory), or may be managed using a management table. The input/output information, signal and the like are capable of being rewritten, updated or edited. The output information, signal and the like may be deleted. The input information, signal and the like may be transmitted to another apparatus.

Notification of the information is not limited to the Aspects/Embodiment described in the present Description, and may be performed using another method. For example, notification of the information may be performed using physical layer signaling (e.g., Downlink Control Information (DCI), Uplink Control Information (UCI)), higher layer signaling (e.g., RRC (Radio Resource Control) signaling, broadcast information (Master Information Block (MIB), System Information Block (SIB) and the like), MAC (Medium Access Control) signaling), other signals, or combination thereof.

In addition, the physical layer signaling may be called L1/L2 (Layer 1/Layer 2) control information (L1/L2 control signal), L1 control information (L1 control signal) and the like. Further, the RRC signaling may be called RRC message, and for example, may be RRC connection setup (RRC Connection Setup) message, RRC connection reconfiguration (RRC Connection Reconfiguration) message, and the like. Furthermore, for example, the MAC signaling may be notified using MAC Control Element (MAC CE).

Further, notification of predetermined information (e.g., notification of “being X”) is not limited to explicit notification, and may be performed implicitly (e.g., notification of the predetermined information is not performed, or by notification of different information).

The decision may be made with a value (“0” or “1”) expressed by 1 bit, may be made with a Boolean value represented by true or false, or may be made by comparison with a numerical value (e.g., comparison with a predetermined value).

Irrespective of that the software is called software, firmware, middle-ware, micro-code, hardware descriptive term, or another name, the software should be interpreted widely to mean a command, command set, code, code segment, program code, program, sub-program, software module, application, software application, software package, routine, sub-routine, object, executable file, execution thread, procedure, function and the like.

Further, the software, command, information and the like may be transmitted and received via a transmission medium. For example, when the software is transmitted from a website, server or another remote source using wired techniques (coaxial cable, optical fiber cable, twisted pair, Digital Subscriber Line (DSL) and the like) and/or wireless techniques (infrared, microwave and the like), these wired techniques and/or wireless techniques are included in the definition of the transmission medium.

The terms of “system” and “network” used in the present Description are used interchangeably.

In the present Description, the terms of “Base Station (BS)”, “radio base station”, “eNB”, “gNB”, “cell”, “sector”, “cell group”, “carrier” and “component carrier” are capable of being used interchangeably. There is the case where the base station is called by the terms of fixed station, NodeB, eNodeB (eNB), access point, transmission point, reception point, femto-cell, small cell and the like.

The base station is capable of accommodating one or a plurality of (e.g., three) cells (also called the sector). When the base station accommodates a plurality of cells, the entire coverage area of the base station is capable of being segmented into a plurality of smaller areas, and each of the smaller areas is also capable of providing communication services by a base station sub-system (e.g., small base station (RRH: Remote Radio Head) for indoor use). The term of “cell” or “sector” refers to a part or the whole of coverage area of the base station and/or base station sub-system that performs communication services in the coverage.

In the present Description, the terms of “Mobile Station (MS)”, “user terminal”, “User Equipment (UE)”, and “terminal” are capable of being used interchangeably.

There is the case where the Mobile Station may be called using a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms, by a person skilled in the art.

Further, the radio base station in the present Description may be read with the user terminal. For example, each Aspect/Embodiment of the present disclosure may be applied to a configuration where communication between the radio base station and the user terminal is replaced with communication among a plurality of user terminals (D2D: Device-to-Device). In this case, the functions that the above-mentioned radio base station 10 has may be the configuration that the user terminal 20 has. Further, the words of “up”, “down” and the like may be read with “side”. For example, the uplink channel may be read with a side channel.

Similarly, the user terminal in the present Description may be read with the radio base station. In this case, the functions that the above-mentioned user terminal 20 has may be the configuration that the radio base station 10 has.

In the present Description, operation performed by the base station may be performed by an upper node thereof in some case. In a network including one or a plurality of network nodes having the base station, it is obvious that various operations performed for communication with the terminal are capable of being performed by the base station, one or more network nodes (e.g., MME (Mobility Management Entity), S-GW (Serving-Gateway) and the like are considered, but the invention is not limited thereto) except the base station, or combination thereof.

Each Aspect/Embodiment explained in the present Description may be used alone, may be used in combination, or may be switched and used according to execution. Further, with respect to the processing procedure, sequence, flowchart and the like of each Aspect/Embodiment explained in the present Description, unless there is a contradiction, the order may be changed. For example, with respect to the methods explained in the present Description, elements of various steps are presented in illustrative order, and are not limited to the presented particular order.

Each Aspect/Embodiment explained in the present Description may be applied to LTE (Long Term. Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (Registered Trademark) (Global System for Mobile communications), CDMA 2000, UMB (Ultra Mobile Broadband), IEEE 802.11 (Wi-Fi (Registered Trademark)), IEEE 802.16 (WiMAX (Registered Trademark)), IEEE 802.20, UWB (Ultra-WideBand), Bluetooth (Registered Trademark), system using another proper radio communication method and/or the next-generation system extended based thereon.

The description of “based on” used in the present Description does not mean “based on only”, unless otherwise specified. In other words, the description of “based on” means both of “based on only” and “based on at least”.

Any references to elements using designations of “first”, “second” and the like used in the present Description do not limit the amount or order of these elements overall. These designations are capable of being used in the present Description as the useful method to distinguish between two or more elements. Accordingly, references of first and second elements do not mean that only two elements are capable of being adopted, or that the first element should be prior to the second element in any manner.

There is the case where the term of “determining” used in the present Description includes various types of operation. For example, “determining” may be regarded as “determining” calculating, computing, processing, deriving, investigating, looking up (e.g., looking up in a table, database or another data structure), ascertaining and the like. Further, “determining” may be regarded as “determining” receiving (e.g., receiving information), transmitting (e.g., transmitting information), input, output, accessing (e.g., accessing data in memory) and the like. Furthermore, “determining” may be regarded as “determining” resolving, selecting, choosing, establishing, comparing and the like. In other words, “determining” may be regarded as “determining” some operation.

The terms of “connected” and “coupled” used in the present Description or any modifications thereof mean direct or indirect every connection or coupling among two or more elements, and are capable of including existence of one or more intermediate elements between two mutually “connected” or “coupled” elements. Coupling or connection between elements may be physical, may be logical or may be combination thereof. For example, “connection” may be read with “access”.

In the present Description, in the case where two elements are connected, it is possible to consider that two elements are mutually “connected” or “coupled”, by using one or more electric wires, cable and/or print electric connection, and as some non-limited and non-inclusive examples, electromagnetic energy having wavelengths in a radio frequency region, microwave region and/or light (both visible and invisible) region, or the like.

In the present Description, the terms of “A and B are different” may mean that “A and B are different from each other”. The terms of “separate”, “coupled” and the like may be similarly interpreted.

In the case of using “including”, “comprising” and modifications thereof in the present Description or the scope of the claims, as in the term of “provided with”, these terms are intended to be inclusive. Further, the term of “or” used in the present Description or the scope of the claims is intended to be not exclusive OR.

As described above, the invention according to the present disclosure is described in detail, but it is obvious to a person skilled in the art that the invention according to the disclosure is not limited to the Embodiment described in the present Description. The invention according to the disclosure is capable of being carried into practice as modified and changed aspects without departing from the subject matter and scope of the invention defined by the descriptions of the scope of the claims. Accordingly, the descriptions of the present Description are intended for illustrative explanation, and do not provide the invention according to the disclosure with any restrictive meaning.

1. A user terminal comprising:
a receiving section that receives downlink control information for indicating activation of a predetermined BWP among one or more partial frequency bands (BWP: Bandwidth Part) configured within a carrier; and
a control section that controls activation of one or a plurality of BWPs based on at least one of the downlink control information, MAC control information and higher layer signaling.

2. The user terminal according to claim 1, wherein when a timer configured for one or more activated BWPs expires, the control section controls to activate a default BWP.

3. The user terminal according to claim 1, wherein when a plurality of BWPs is activated, the control section controls to perform radio link monitoring selectively on a predetermined BWP.

4. The user terminal according to claim 1, wherein the control section controls to activate a plurality of BWPs only in a predetermined cell.

5. The user terminal according to claim 1, wherein when a plurality of BWPs is activated, at least one of a control resource set and search space configuration is configured for a particular BWP among the plurality of BWPs.

6. A radio communication method of a user terminal, including:
receiving downlink control information for indicating activation of a predetermined BWP among one or more partial frequency bands (BWP: Bandwidth Part) configured within a carrier; and
controlling activation of one or a plurality of BWPs based on at least one of the downlink control information, MAC control information and higher layer signaling.

7. The user terminal according to claim 2, wherein when a plurality of BWPs is activated, the control section controls to perform radio link monitoring selectively on a predetermined BWP.

8. The user terminal according to claim 2, wherein the control section controls to activate a plurality of BWPs only in a predetermined cell.

9. The user terminal according to claim 2, wherein when a plurality of BWPs is activated, at least one of a control resource set and search space configuration is configured for a particular BWP among the plurality of BWPs.

10. The user terminal according to claim 3, wherein when a plurality of BWPs is activated, at least one of a control resource set and search space configuration is configured for a particular BWP among the plurality of BWPs.

11. The user terminal according to claim 4, wherein when a plurality of BWPs is activated, at least one of a control resource set and search space configuration is configured for a particular BWP among the plurality of BWPs.
